(19) United States
(12) Patent Application Publication
(10) Pub. No.: US 2016/0223446 A1
(43) Pub. Date: Aug. 4, 2016

(54) Generating Pressure Fluctuations In A Line

(71) Applicant: EUCATECH AG, Weil am Rhein (DE)

(72) Inventor: Michael Giese, Schopfheim (DE)

(21) Appl. No.: 14/891,484

(22) PCT Filed: Jul. 4, 2013
(86) PCT No.: PCT/EP2013/064171

§ 371 Date: Mar. 21, 2016

(30) Foreign Application Priority Data
May 16, 2013 (DE) 10 2013 105 037.9

(51) Int. Cl. G01N 3/36

(52) U.S. Cl. CPC G01N 3/36

(57) ABSTRACT

For generating pressure fluctuations (Δρ) in a fluid (8), the fluid is fed at a constant rate into the inlet (4) of the line (2), the line (2) is flowed through by the fluid (8) and the volume flow of the fluid (8) is throttled to varying degrees at the outlet (6) dynamically over time, in particular periodically, in order by the varying of the throttling to produce pressure fluctuations (Δρ) in the fluid (8) upstream in the line (2) dynamically over time. On a pressure modulator (24), an outlet opening (26) can be connected to a line (2), wherein the outlet opening (26) opens out into a clearance (28), and so during operation the fluid (8) leaves the outlet opening (26) as a fluid jet (30) along a fluid path (32) and enters the clearance (28). An impact body (34), which can be introduced into the fluid path (32) in a manner varying dynamically over time, at least temporarily forms an impact surface (36, 36a-c), which is impinged by at least part of the fluid jet (30) during operation.

The invention concerns a method and a pressure modulator for generating pressure fluctuations in a fluid which is located in a line, as well as a pipeline arrangement with a line in which pressure fluctuations can be generated in a fluid present in the line.

In many application instances it is desirable to generate pressure fluctuations in a fluid which is present in a line. The term line here stands for a single line, a piping system of communicating lines, such as a pipe system or some other arrangement of hollow bodies in which a fluid is present, which is to be subjected to pressure fluctuations.

The invention is applicable to many fields of technology, e.g., the testing of medical stents or bursting pressure tests, and shall be explained below only as an example with the aid of a pipeline arrangement in the form of a test layout for medical stents. The generic term stent subsumes stents, grafts, combinations of these and similar objects. Before stents go into clinical use, they must be tested thoroughly. In particular, fatigue tests are conducted during which the stents are subjected to deformations.

A test layout for stents is known, e.g., from U.S. Pat. No. 5,670,708. A radial flexible line in which the stent is installed simulates a blood vessel. A fluid in the line simulates blood and pressure pulses in the fluid simulate the blood pressure fluctuations due to the beating heart of the patient. Thus, a radial expansion and contraction of the line and thus a cyclical deformation of the stent occurs. Pressure pulses in the fluid are generated by expansion and compression of a bellows. The stents are deformed, following the radial movement of the line, and are thus subjected to the fatigue test.

Stents are generally tested for a lifetime of ten years, which for an average human heart rate corresponds to around a total of 100 million pressure pulses. The drawback to the known arrangement is that the bellows is deformed during each pressure pulse, and thus exposed to a high constant loading and is itself subject to fatigue effects.

The problem which the invention proposes to solve is to indicate an improved method of generating pressure fluctuations in a line containing a fluid, as well as an improved pressure modulator and an improved pipeline arrangement.

In regard to the method, the problem is solved by a method according to patent claim 1 for generating pressure fluctuations in a fluid which is present in a line. The line is in particular a line system of a test layout for a medical stent, wherein the pipeline arrangement has a test section which can be expanded by an increasing of the fluid pressure. The stent is placed or can be placed in the test section. The method has the following steps:

The line is flowed through by the fluid from an inlet of the line to its outlet. At the inlet the fluid is delivered at a constant volume flow (volume per unit of time) into the inlet. At the outlet the volume flow of the fluid flowing from the outlet is throttled to varying degrees, dynamically over time. The dynamic throttling over time occurs here periodically, in particular. Thanks to the dynamic variation of the throttling over time, i.e., the different degrees of throttling of the outgoing fluid at different moments of time, dynamic pressure fluctuations over time are generated upstream in the line, i.e., a pressure variation in the fluid in the line which varies over the course of time—especially periodically.

Thus, the invention makes conscious use of the principle of the pressure surge, which is generally undesirable in pipeline systems. A pressure surge arises upstream in a line due to a downstream throttling of a fluid flow in the line, for example, with the help of a shutoff fitting. For a fluid in the form of a liquid, the effect of pressure surges is greater for the same throttling—that is, the pressure fluctuations are greater—than in the case of gaseous fluids, since liquids are less compressible than gases. The pressure surges are propagated from the site of the throttling, i.e., the shutoff fitting for example, upstream into the line.

Fluid in the aforementioned test for stents therefore means in particular a liquid, and a physiological salt solution is chosen in particular as the liquid. Thanks to using a liquid, the desired effect of the pressure surges is intensified as compared to gaseous fluids. The table salt solution is especially suitable for stent testing. The method according to the invention thanks to the use of the pressure surge principle affords the advantage that any suitable mechanical type throttling device can be used for the throttling of the fluid flow or for the variable throttling. Embodiments as a valve, sliding gate, impact plate and so forth are conceivable here. These devices generally make do with no elastically deformable elements and are therefore subject to significantly less wear, especially compared to the known devices with bellows. The method can thus be carried out with less wear than the know method. The delivery of the fluid to the inlet of the line can likewise be done with known low-wear devices, such as the use of a pulsation-free pump, such as a gear pump. Thanks to the reduced wear on the components involved, the method is especially advantageous in terms of reliability and availability.

In the test layout the expandable test section is cylindrical in particular, e.g., in the form of a flexible hose, such as a silicone hose. A stent can be introduced and held there. The stent is held in that the expandable test section holds a less flexible stent by a radially inward directed spring force and/or the stent itself is flexible in design and thus it is prestressed in the test section with radially outward spring action. In particular, the pipeline system with the exception of the test section is rigid in design, i.e., not expandable, so that only the test sections expand due to the pressure fluctuations in the pipeline system, since only these can yield under a pressure increase. The fluid in the line is maintained free of bubbles especially in the case of liquids, i.e., free of gas, for otherwise pressure falsifications will occur when the gas volume present in the bubbles is compressed and therefore the pressure fluctuations will not act solely on the test section, as desired.

Thanks to an increasing of the throttling or an increasing of the flank stiffness in the time plot of the throttling, i.e., a stronger or faster throttling of the volume flow, there is an intensified pressure increase upstream. Therefore, by changing the mentioned parameters of the throttling, pressure fluctuations and pressure variations of different degree can be set. For example, shutoff valves or other throttling fixtures can be used for the throttling of different degree, which reduce the available flow cross section for the fluid.

In a preferred embodiment, the fluid emerges as a fluid jet along a fluid path from an outlet opening downstream from the outlet into a clearance. For the throttling of different degrees, an impact body is introduced in the clearance in different relative positions to the fluid path therein and in the fluid jet. Thus, at least one portion of the fluid jet impinges on the impact body at least some of the time. The site of impinging of the fluid jet on the impact body, i.e., the part of the impact body struck by fluid in the form of the fluid jet, then forms an impact surface. In other words, the impact body is subjected at least temporarily to at least a portion of the fluid emerging from the outlet in the fluid jet. By impinging on the impact body, the fluid jet experiences a back flow, which results in the aforementioned pressure surge. The “variable” introducing of the impact body includes every variation, e.g., a variable spatial position or orientation of the impact body in the fluid path. It also includes a temporary complete removal of the impact body from the fluid jet, so that the fluid jet can emerge unhindered from the outlet for some of the time and not produce any back flow. For example, a linear back and forth movement of the impact body is conceivable, wherein the line of motion can be situated in any given orientation to the axis of the fluid jet, as long as a pressure surge effect is created. The variable introducing of the impact body in the fluid path can be done especially easily and free of wear.

Furthermore, the variable introducing is to be understood in the sense of a changing of the relative position of impact body and outlet opening relative to each other. In a fixed reference system, therefore, the impact surface and/or the fluid jet or the fluid path is moved in order to create different relative positions between impact body and fluid jet. The changing of the fluid path is done in particular by changing the outlet opening determining the fluid path by steering the fluid jet. The impact body can have a surface of any given shape. By a fluid jet is meant the pressurized outflow of the fluid upon exiting from the outlet opening, thus in particular not a pressure-less fluid draining away simply due to gravity, for example. What is decisive is that the introducing of the impact body into the fluid jet in fact causes a pressure surge effect upstream in the fluid or in the line.

In a preferred variant of this embodiment, for the throttling of different degrees a spacing and/or an angle of inclination of the impact surface to the outlet opening and/or a degree of overlap between the cross sectional area of the fluid jet and the projection surface of the impact surface on the cross sectional area—looking in the direction of the emerging fluid jet—is varied dynamically. Here again, the “change” is to be understood relatively, that is, in a fixed reference system the fluid jet is changed relative to the impact surface and/or the impact surface relative to the fluid jet. Spacing, angle of inclination and degree of overlap can likewise be realized by very simple and low-wear movements of impact body and/or fluid path.

In another preferred variant of the aforementioned embodiment, for the throttling to different degrees the impact body and the fluid path are moved relatively to each other such that each time different parts of the surface of the impact body form impact surfaces introduced variously into the fluid jet on account of the movement between different relative positions. In other words, at least one portion of the fluid jet thanks to the relative movement of impact body and fluid jet impinges on different segments of its surface, i.e., impact surfaces, on the impact body. This enables, for example, a dynamic movement of the impact body in the form of being led through the fluid jet. The impact body can then be outfitted with a surface profile or height profile, i.e., other points of impinging of the fluid on the impact body form other impact surfaces. For example, the impact body can be configured as a rotating perforated disk, wherein the fluid jet impinges alternately on certain regions of the impact body and/or passes through its perforations. Thus, the changing of the throttling can be done especially easily by structuring of the impact body in combination with its movement.

In one variant of the aforementioned embodiment the relative movement between impact body and fluid jet occurs by a rotation about an axis of rotation, wherein the impact body in particular is rotated. The rotation in this case can also be part of an overall movement, i.e., combined with other movements, such as linear ones. In particular, a rotational movement of the impact body can be realized in especially easy and low-wear manner by means of a rotary bearing.

In another variant of this embodiment the relative movement can be a translatory movement between fluid path and impact body. This can also be part of an overall movement, as explained above. Translatory movements are also possible with low wear. By changing the translatory position in particular the throttling can be adjusted so that, for example, a lower and upper pressure level is established for pressure fluctuations. The cyclical pressure fluctuation between the two levels is then accomplished or superimposed by a rotational movement.

In regard to the pressure modulator, the problem is solved by a pressure modulator according to patent claim 7. The pressure modulator contains an outlet opening, which can be connected such to a line through which fluid is flowing that the outlet opening forms the exit end of the line through which—preferably all of—the fluid flowing through the line emerges. The outlet opening empties into a clearance. In operation, i.e., when fluid is flowing through the line, fluid emerges from the outlet into the clearance and forms a fluid jet in the clearance, which moves along a fluid path through the clearance. In other words, after emerging from the outlet opening, the fluid fills the fluid path in the form of the fluid jet. The pressure modulator furthermore has an impact body which can be introduced into the fluid path in different ways, dynamically over time. At least some of the time, i.e., when at least one part of the impact body is dipped into the fluid path, the impact body forms an impact surface, on which at least a portion of the fluid jet impinges during operation. In other words, the impact surface is that part of the impact body in the flow of fluid of the fluid jet.

Due to the impinging on the impact surface, the volume flow of the fluid is throttled to different degrees, dynamically over time. Thus, dynamic pressure fluctuations over time are created in the fluid upstream, e.g., in a line connected to the pressure modulator. The pressure modulator according to the invention is therefore especially suitable for connection to the outlet of a line or a piping system in order to bring about the throttling of the fluid to different degrees dynamically over time in the above-described method. In particular, the pressure modulator can be designed so that its only moving part is the impact body. As explained above, the impact body can be moved with especially low wear, so that the pressure modulator is especially suitable for the above-mentioned stent testing, requiring many millions of pressure fluctuations. Otherwise, the same remarks about the method according to the invention also apply to the pressure modulator and its operation.

In a preferred embodiment, the spacing and/or the angle of inclination of the impact surface to the outlet and/or the degree of overlap between the cross sectional area of the fluid path and the projection area of the impact surface on this cross sectional area is variable.

In another preferred embodiment, impact body and fluid path, especially the outlet opening determining the fluid path, can be adjusted or moved relative to each other so that each time different parts of the surface of the impact body form impact surfaces protruding variously into the fluid path on account of the adjustment or movement between different relative positions.

In one variant of this embodiment, impact body and fluid path, especially the outlet opening determining the fluid path, are rotatable relative to each other about an axis of rotation. Rotational movements can be performed with especially low wear and simple design, so that different parts of the surface of the impact body can be introduced variously as impact surfaces into the fluid path in especially advantageous manner. As an especially simple variant, only the impact body is rotated.

In another variant of this embodiment, alternatively or in addition the outlet opening determining the fluid path can be rotated eccentrically about an axis of rotation, especially one parallel to a jet direction of the fluid path. Eccentric movements are mechanically easy to perform and can be easily achieved in terms of fluid tightness. Thanks to the movement of the outlet opening, the fluid path also changes and thus, in particular for a position-invariant impact body, so does the site of impinging of the fluid jet on the impact body, i.e., the impact surface. By configuring the impact body with different impact surfaces in this respect, once again parameters of the pressure fluctuations can be changed. The position invariance of the impact body includes, e.g., a movement of the impact body in itself, such as the rotation of an impact body with rotational symmetry in contour, as a perforated disk.

In another preferred embodiment, impact body and fluid path, especially the outlet opening determining the fluid path, can be moved in translation relative to each other.

In another embodiment, the impact body has a surface topography, especially a height profile and/or interruptions, which is distributed over the impact body such that, when it is introduced variously into the fluid path, different segments of the surface topography lie alternately in the fluid path. A height profile is to be understood here in relation to the spacing of the surface of the impact body from the outlet opening. The surface topography extends for example along a curve on the surface of the impact body, wherein different impact surfaces are formed on the curve, against which the fluid jet impinges during operation.

In other words, the impact body is profiled or shaped such that, for example, recesses, elevations, or interruptions are introduced into the impact body. For example, the impact body is a disk with recesses, especially through openings, or a profile curve, i.e., a height profile, which is fashioned in the circumferential direction about an axis of rotation. This configuration is especially advisable in combination with embodiments in which the impact body is rotated about an axis parallel to the jet axis of the fluid jet.

For the mentioned embodiments of the pressure modulator and their benefits, the above remarks in connection with the method of the invention also apply.

In regard to the pipeline arrangement, the problem is solved by a pipeline arrangement according to patent claim 14 with a line having an inlet and an outlet. The line is configured to be flowed through with a fluid from the inlet to the outlet. In particular, the line is configured as a pipeline system of a test layout for a medical stent, wherein the pipeline system then has a test section. This can be expanded by a pressure fluctuation in the form of an increase in the pressure of the fluid. The stent can be placed in the test section. The pipeline arrangement has a delivery mechanism for the fluid, in order to deliver the fluid at the inlet at a constant rate to the inlet of the line. The pipeline arrangement furthermore has a throttle element for the fluid, in order to throttle the volume flow of the fluid emerging from the outlet to different degrees dynamically over time, especially periodically—especially at or in the immediate vicinity of the outlet, especially downstream. This serves to generate dynamic pressure fluctuations of the fluid upstream in the line by the dynamic change in the throttling over time.

The pipeline arrangement is therefore especially suitable to carry out the method according to the invention and thus especially as a particularly wear-free test layout for medical stents with the aforementioned benefits. The throttle element is, for example, a proportional valve or another throttle element which throttles the volume flow of the fluid by changing a cross sectional area for the fluid. This can be connected in series with the outlet, especially in an adjoining line piece downstream.

In one preferred embodiment, the delivery element is a pump designed to feed a fluid into the entrance at constant rate. Unlike a membrane pump, which would be subject to wear on the membrane during a stent fatigue test, a gear pump has especially low wear.

In another preferred embodiment, the throttle element is a pressure modulator connected in series with the outlet of the line downstream, such as was described above, and bringing with it the accordingly mentioned benefits.

For a further description of the invention, reference is made to the sample embodiments of the drawing. There are shown each time in schematic diagram:

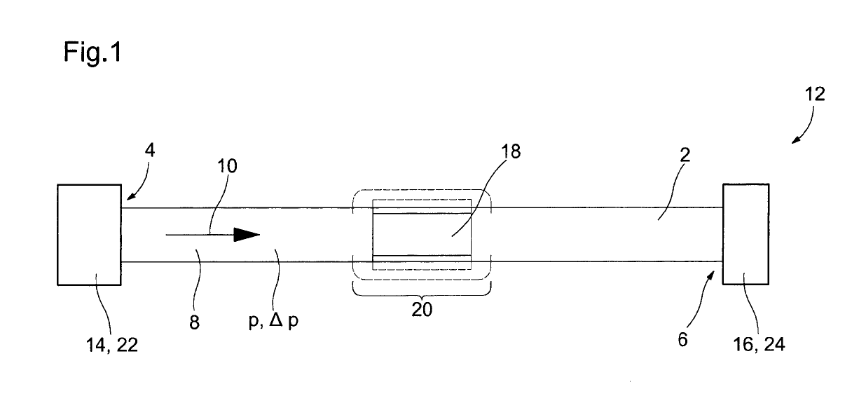

FIG. 1 a pipeline arrangement or test layout for a stent

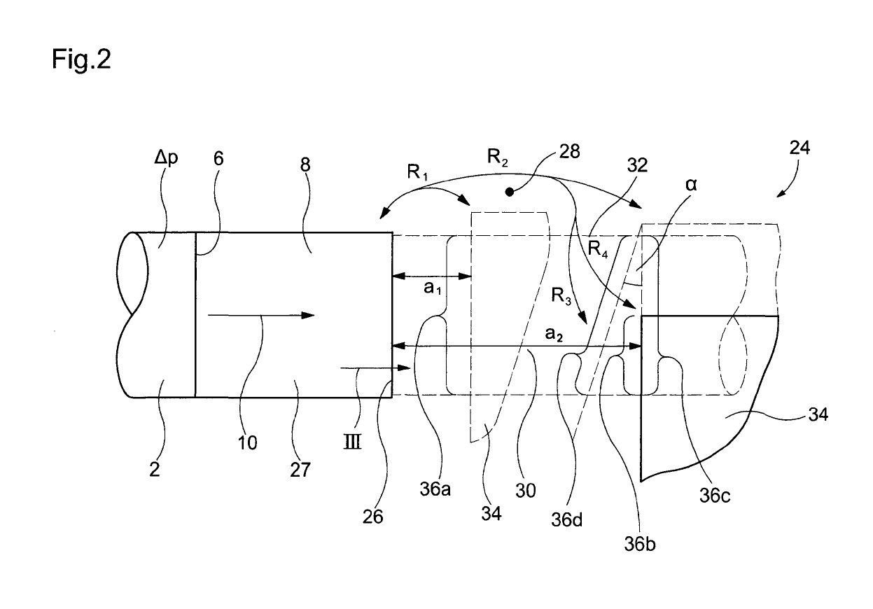

FIG. 2 a pressure modulator

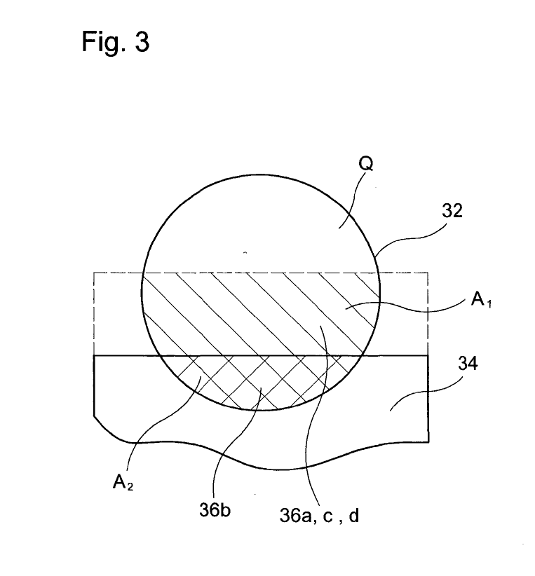

FIG. 3 a detail of the pressure modulator of FIG. 2 in cross section

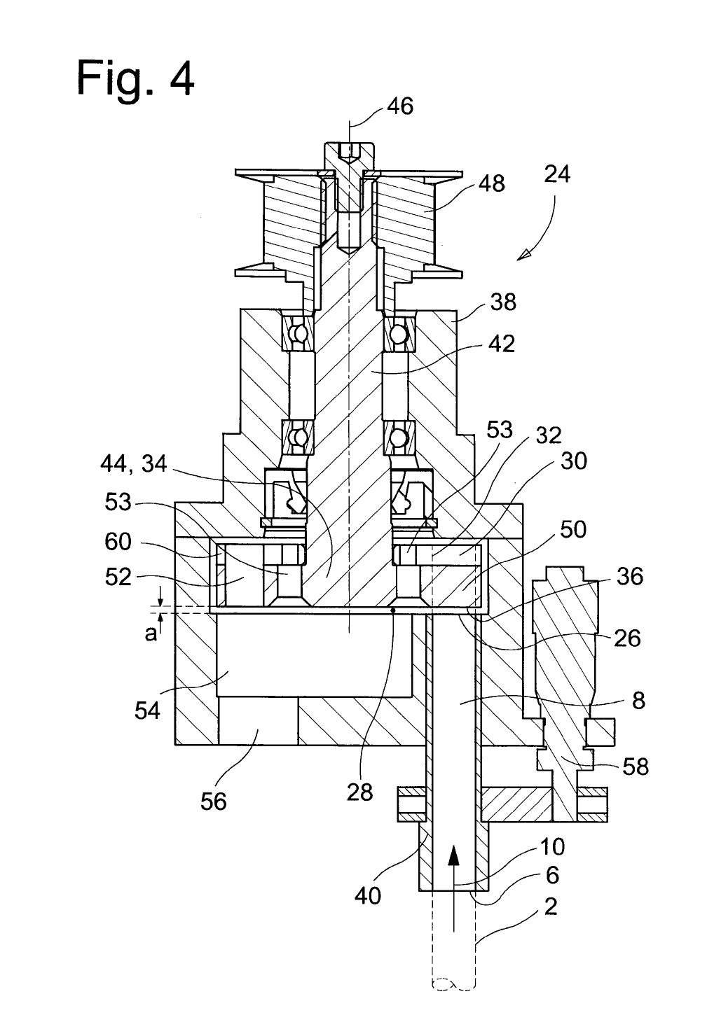

FIG. 4 an alternative pressure modulator with perforated disk

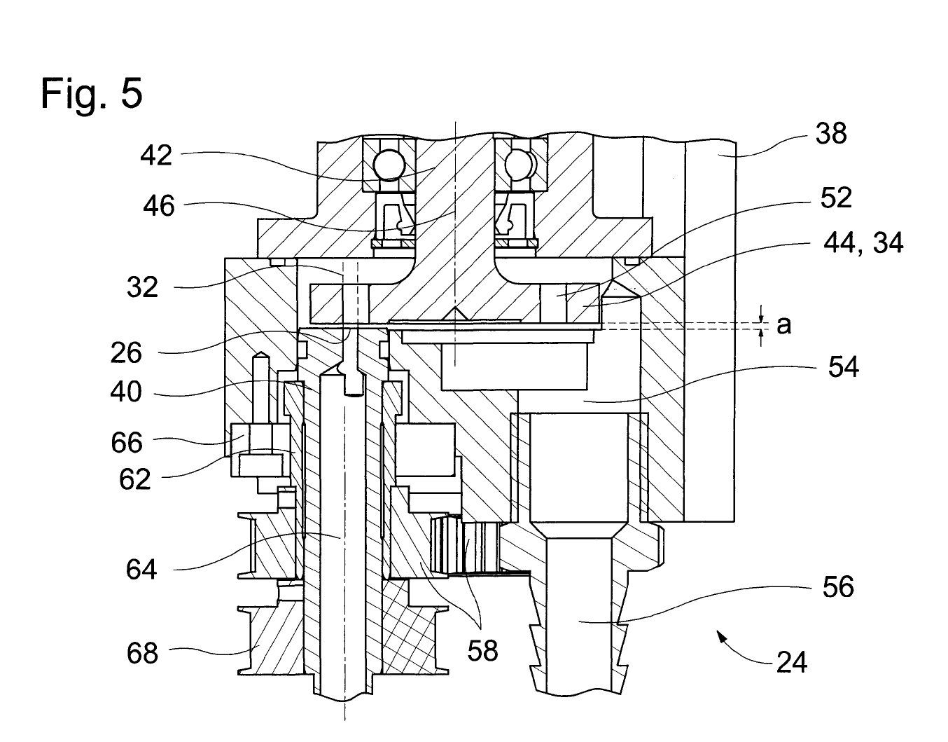

FIG. 5 another alternative pressure modulator with eccentric adjustment of the outlet opening

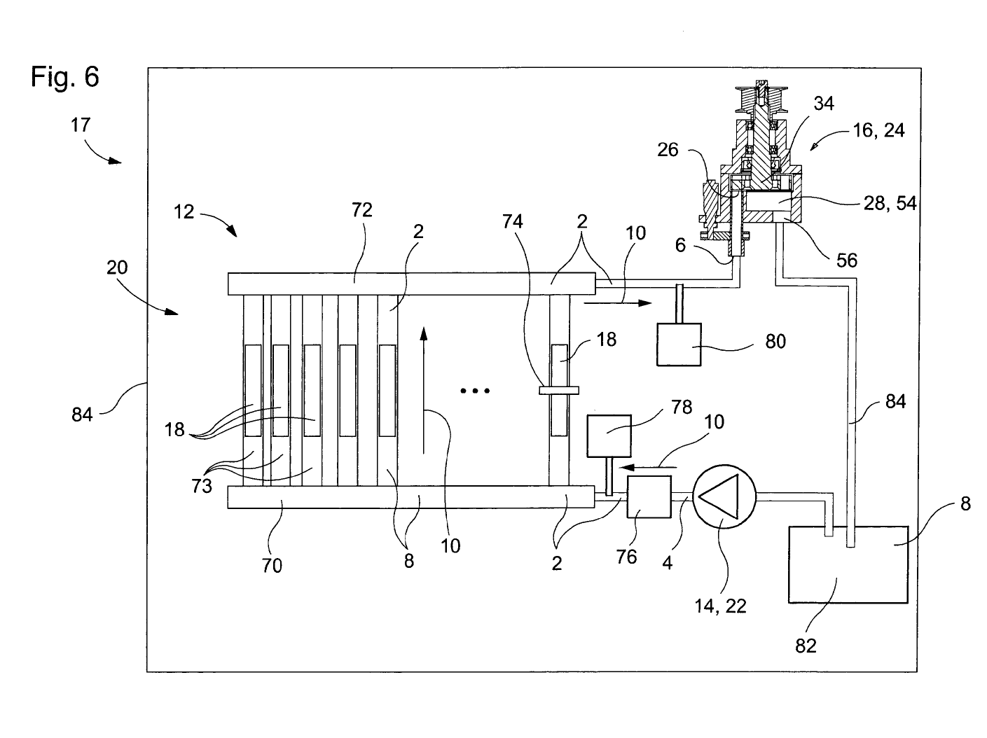

FIG. 6 an alternative test layout for stents

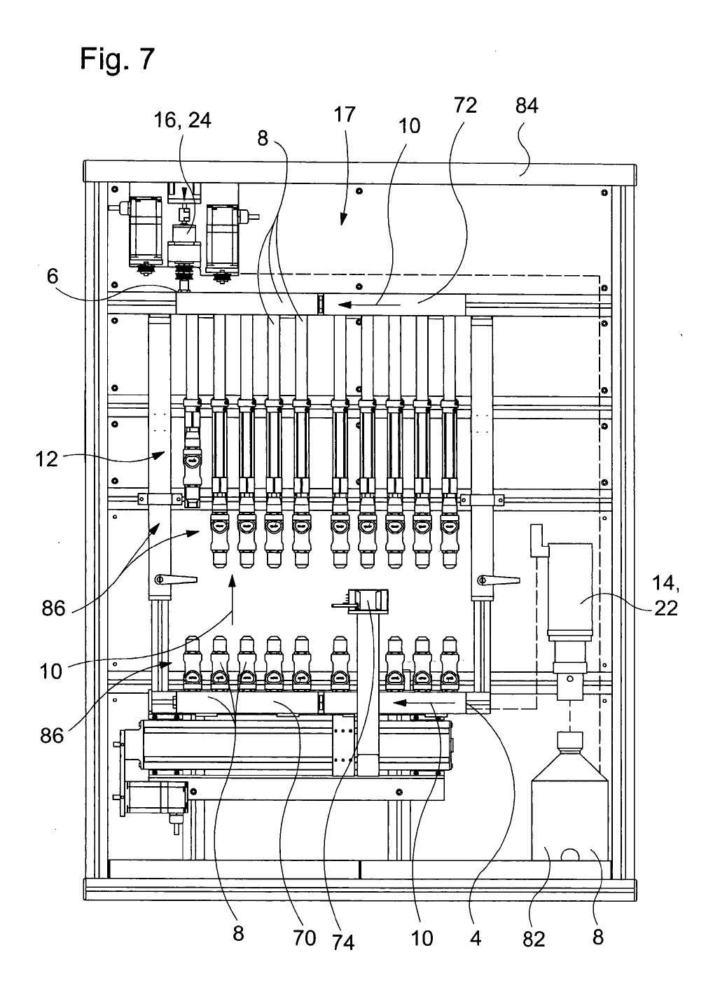

FIG. 7 another alternative test layout for stents

FIG. 1 shows a line 2 with an inlet 4 and an outlet 6. Through the line 2 there flows a fluid 8 from the inlet 4 to the outlet 6 in a flow direction according to the arrow 10. A pipeline arrangement 12 contains, besides the line 2, a delivery mechanism 14 for the fluid 8, in order to deliver it at constant rate into the inlet 4 of the line 2. Furthermore, the pipeline arrangement 12 contains a throttle element 16 for the fluid 8. The throttle element 16 is connected in series to the outlet 6 and it throttles the volume flow of the entire fluid 8 emerging from the outlet 6. The throttling is dynamic over time, i.e., of different intensity over the course of time, especially periodical. Thanks to the change in intensity of the throttling, dynamic pressure fluctuations Δp of the pressure p of the fluid 8 in the line 2 arise over the course of time upstream from the throttle element 16, i.e., opposite the direction of the arrow 10.

The pipeline arrangement 12 in an alternative embodiment is part of a test layout 17 for a medical stent 18, not further represented in FIG. 1. The line 2 then has a test section 20, in which the stent 18 is placed, namely, being prestressed radially outward with spring action. The test section 20 of the line 2 can be radially expanded by pressure fluctuations Δp in the form of a rise in pressure p in the fluid 8, as indicated by the broken line in FIG. 1. The stent 18 then follows the expansion in the test section 20 and is mechanically deformed in this way. Upon drop in the pressure p, a contrary movement occurs. By cyclical pressure fluctuations Δp the stent 18 is therefore subjected to a fatigue testing.

The delivery mechanism 14 in the example is a pump 22 feeding the fluid 8 to the inlet 4, being designed for a constant rate, especially a gear pump. The throttle element 16 in the example is a pressure modulator 24 connected to the outlet 6.

FIG. 2 shows the pressure modulator 24 of FIG. 1 in more detail. The pressure modulator contains an outlet opening 26, which is fashioned in the example as an open end of a pipe piece 27, which is connected to the line 2 with the flow of fluid 8 or to its outlet 6. All of the fluid 8 flowing through the outlet 6 thus emerges from the outlet opening 26. The outlet opening 26 empties into a clearance 28 of the pressure modulator 24. In operation, i.e., when fluid 8 is flowing through the line 2, the fluid emerges at the outlet opening 26 into the clearance 28 and in this process forms a fluid jet 30, which moves along a three-dimensional, spatially extended fluid path 32 through the clearance 28; in FIG. 2 the fluid path 32 is shown by broken line. An impact body 34 of the pressure modulator 24 can be introduced into and also removed from the fluid path 32 in a manner varying over time. In operation, i.e., when the fluid jet 30 is present, at least a portion of the fluid jet 30, i.e., the fluid 8, impinges on the impact body 34 whenever at least a portion of the impact body 34 protrudes into the fluid path 32. The particular surface region of the impact body 34 which is struck by the fluid jet 30 at the moment then forms a respective impact surface 36a-c of the impact body 34.

FIG. 2 shows four different relative positions R₁₋₄ between impact body 34 (one solid and two broken line) and fluid path 32 or fluid jet 30. Each time, different impact surfaces 36a-d are formed on the impact body 34. Thanks to the introducing of the impact body 34 dynamically varying over time into the fluid path 32 in or between the relative positions R₁₋₃ indicated, pressure surges of the pressure p in the fluid 8 occur during operation, which are propagated upstream into the line 2, i.e., opposite the flow direction of the fluid 8, i.e., opposite the direction of the arrow 10, in the form of pressure fluctuations Δp.

Due to the translatory and/or rotary movement and/or slanting movement of the impact body 34, the spacing a_{1,2} between impact surface 36a-d and outlet opening 26 changes in a first variant—looking in the jet direction of the fluid jet 30 or along the fluid path 32. Alternatively or in addition, the angle of inclination α between the impact surface 36a-d and the outlet opening 26 changes.

FIG. 3 shows, looking in the direction of arrow III in FIG. 2, i.e., in the jet direction, how the different introducing of the impact body 34 in different relative positions R₁₋₃ alternatively or additionally also changes a degree of overlap G=Q/A_{1,2}. This describes the areal ratio between the cross sectional area Q of the fluid path 32 and the projection areas A_{1,2} of the projections of the impact surfaces 36a-d on this cross sectional area Q or the corresponding cross sectional plane. In FIG. 3 the different positions of the impact body 34 are shown solid and the broken line shows the resulting different impact surfaces 36a-d and their projection areas A_{1,2} by different hatch marks.

FIG. 4 shows an alternative embodiment of a pressure modulator 24 with a housing 38, in which a Pitot tube 40 is provided. The Pitot tube 40 is functionally similar to the additional pipe piece 27 of FIG. 2, being connected at the outlet 6 of the line 2 and ending for its part in the outlet opening 26. The housing 38 encloses the clearance 28, in which the impact body 34 is arranged. The fluid path 32 extends starting at the outlet opening 26 into the clearance 28. The impact body 34 is realized here as a circular disk 44, which is joined as a single piece to a shaft 42. Shaft 42 and disk 44 can rotate about an axis of rotation 46. A rotational drive occurs in a manner not explained more closely across a belt (not shown) and a belt pulley 48 or alternatively through other drive variants, not represented, such as a direct drive. The disk 44 has distributed around its circumference massive segments 50 and interruptions 52 in the form of through boreholes. Thanks to the rotation of the disk 44 about the axis of rotation 46, the massive segments 50 or the interruptions 52 alternately arrive in the region of the fluid path 32. If a massive segment 50 lies in the fluid path 32, an impact surface 36 on the impact body 34 is formed here, as explained in FIGS. 2 and 3 for the impact surfaces 36a-c. If an interruption 52 lies in the region of the fluid path 32, the fluid jet 30 experiences no noticeable resistance and can pass unhindered through the interruption 52, without striking the impact body 34. No impact surface 36 is present in that case.

The impact body 34, i.e., its massive or solid region, is thus alternately brought into the fluid path 32 or not in dynamically alternating manner over time, as it rotates, and thereby forms impact surfaces 36 or not in dynamically alternating manner over time. This produces pressure surges varying in time in the fluid 8, which are propagated contrary to the direction of the arrow 10 in the line 2 and result in pressure fluctuations Δp there. The fluid 8 emerging from the outlet opening 26 gathers free of pressure, after having struck or passed through the impact body 34, in a collection chamber 54, from which it can flow off through a drain 56 with no pressure and thus again arrive at the pump 22, for example, in a circulation, from which it is again delivered into the line 2.

The spacing a in the form of a gap between the rotating impact body 34 and the outlet opening 26 can be changed by moving the Pitot tube 40 with the aid of a motor drive unit 58 in or opposite the direction of the arrow 10 away from the disk 44 or toward it. The spacing a here determines the upper pressure level of the resulting pressure fluctuations Δp. A corresponding lower pressure level can be adjusted in that the effective cross section of the interruptions 52 can be changed with the aid of an aperture disk 60 which can rotate about the axis of rotation 46 relative to the disk 44. In other words, two perforated disks are turned relative to each other about the axis 46 in order to reduce or enlarge the respective effective perforation cross section. Such an adjustment is done, e.g., only once or occasionally during setup or maintenance of the layout, but not during regular operation. The turning of the two disks relative to each other requires a standstill of the layout, since the disks are fixed in rotation relative to each other by a screw connection 53, only hinted at in FIG. 4 and not explained more closely, which has to be loosened to change the rotary position of the two disks and then secured again. In such a perforated disk, if the spacing between the perforations looking in the circumferential direction corresponds to roughly the perforation diameter, one gets a sine curve as the pressure variation.

FIG. 5 shows a cutout of another alternative embodiment of a pressure modulator 24, which resembles the embodiment of FIG. 4 in terms of construction and mode of operation in that a rotating disk 44 with interruptions 52 and massive, solid segments 50 (see FIG. 4, not visible in FIG. 5) serves as the impact body 34 and is rotated about an axis of rotation 46 such that the interruptions 52 and massive segments 50 of the disk 44 alternately lie opposite the outlet opening 26 of the Pitot tube 40. The adjustment of the spacing a is done in the aforementioned manner by a motor drive unit 58, which here brings about the rotation of a guide body 62 about an axis of rotation 64. Thanks to a screw engagement between the guide body 62 and a mating body 66 firmly disposed on the housing 38, a displacement of the guide body 62 occurs in the axial direction of the axis of rotation 64, carrying along the Pitot tube 40. This adjustment option again serves to adjust the upper pressure level of the pressure fluctuations Δp.

The lower pressure level is set in alternative fashion in the embodiment of FIG. 5, namely, by rotation of the Pitot tube 40 about the axis of rotation 64 with the aid of the belt pulley 68. To make an adjustment possible, the outlet opening 26 on the Pitot tube 40 is disposed eccentrically in regard to the axis of rotation 64. Upon rotation of the Pitot tube 40, there thus occurs a shifting of the position of the outlet opening 26 to the disk 44, i.e., their radial spacing from the axis of rotation 46 is changed. In this way, the position of the fluid path 32 relative to the disk 44 and thus relative to its interruptions 52 or massive segments 50 also changes. The overlap between the cross section of the fluid path 32 and the interruptions 52 is changed. In this way, the size of the impact surfaces 36a-c created on the impact body 34 (not shown in FIG. 5) also changes, as explained in FIGS. 2 and 3. As compared to the embodiment of FIG. 4, this has the benefit that the lower pressure level can also be adjusted during operation of the pressure modulator 24 free of interruption, by activating the belt pulley 68. The cylindrically shaped Pitot tube 40 with eccentric feature is easily sealed against leakage of fluid 8, for example, by traditional O-rings.

FIG. 6 shows a pipeline arrangement 12 as part of a test layout 17 for stents 18. The pipeline arrangement 12 here contains several lines 2 for fluid 8, including ones configured as a distributor rail 70 and a collector rail 72, as well as ones in the form of several test sections 20, each of which receives the flow from the distributor rail 70 and empties into the collector rail 72. The test sections 20 in the example are artificial vessels 73, such as silicone tubes, in which the stents 18 are inserted prestressed in radially outward direction with spring action. With the exception of the artificial vessels 73, all the rest of the lines 2 are rigid in configuration, i.e., they do not expand upon pressure fluctuations Δp in the fluid 8, so they are shape-stable. Only the artificial vessels expand, carrying along the stents 18, thereby subjecting them to a fatigue testing by radial expansion and compression. To determine the diameter of the individual stents 18, a meter 74 is indicated symbolically. In the test layout 17 there is furthermore hooked up a volume flow meter 76, a thermometer 78 and a pressure gauge 80—each of them for the fluid 8 and indicated symbolically.

The fluid 8 is pressurized only in the region upstream along the arrow 10 between the inlet 4 and the outlet 6 or the outlet opening 26. Already in the clearance 28 or in the collection chamber 54 and in a supply tank 82 as well as in a return line 84, the medium 8 is present without pressure. The delivery mechanism 14 therefore removes fluid 8 from the supply tank 82 in order to feed it at constant rate into the pipeline arrangement 12. The supply tank 82 as well as a chamber 84, enclosing the test layout 17, can be heated.

The alternative test layout 17 of FIG. 7 differs from the test layout 17 of FIG. 6: the distributor rail 70 can move toward or away from the collector rail 72. Furthermore, additional rigid lines 2 are hooked up to the distributor rail 70 and the collector rail 72, ending in respective plugs or sockets of quick couplings 86. Between the respective quick couplings 86 the flexible artificial vessels 73 with stents 18 (not shown) can then be placed. The quick couplings 86 arranged on the collector rail 72 are again able to move separately toward or away from the collector rail 72, in order to enable installing or removing individual artificial vessels or stents during operation. The meter 74 in this embodiment is movably disposed in order to measure different artificial vessels 73 or stents 18 as desired. The line connections between pressure modulator 24, supply tank 82, pump 22 and inlet 4 are only hinted at by broken lines.

### LIST OF REFERENCE SYMBOLS

2 Line
4 Inlet
6 Outlet
8 Fluid
10 Arrow
12 Pipeline arrangement
14 Delivery mechanism
16 Throttle element
17 Test layout
18 Stent
20 Test section
22 Pump
24 Pressure modulator
26 Outlet opening
27 Pipe piece
28 Clearance
30 Fluid jet
32 Fluid path
34 Impact body
36,36a-d Impact surface
38 Housing
40 Pitot tube
42 Shaft
44 Disk
46 Axis of rotation
48 Belt pulley
50 Segment
52 Interruption
53 Screw connection
54 Collection chamber
56 Drain
58 Motor drive unit
60 Aperture disk
62 Guide body
64 Axis of rotation
66 Mating body
68 Belt pulley
70 Distributor rail
72 Collector rail
73 Vessel
74 Meter
76 Volume flow meter
78 Thermometer
80 Pressure gauge
82 Supply tank
84 Chamber
86 Quick coupling
Δp Pressure fluctuation
p Pressure
Q Cross sectional area
a,a_{1,2} Spacing
R₁₋₄ Relative position
G Degree of overlap
α Angle of inclination
A_{1,2} Area

1. A method for generating pressure fluctuations (Δp) in a fluid (8) in a line (2), which is part of a line system (12) of a test layout (17) for a medical stent (18) with a test section (20) which can be expanded by an increasing of the pressure (p) of the fluid (8), in which the stent (18) is placed or can be placed, the method comprising the following steps:
the line (2) is flowed through by the fluid (8) from an inlet (4) to an outlet (6),
at the inlet (4) the fluid (8) is delivered at a constant volume flow into the inlet (4) of the line (2),
at the outlet (6) the volume flow of the fluid (8) flowing from the outlet (6) is throttled to varying degrees, dynamically over time, especially periodically,
wherein, because of the change in the throttling, dynamic pressure fluctuations (Δp) over time are generated in the fluid (8) upstream in the line (2).

2. A method according to claim 1, in which the fluid (8) emerges as a fluid jet (30) along a fluid path (32) from an outlet opening (26) downstream from the outlet (6) into a clearance (28), and for the throttling of different degrees, an impact body (34) is introduced in the clearance (28) in different relative positions (R₁₋₄) to the fluid path (32) therein, so that at least a portion of the fluid jet (30) impinges on an impact surface (36,36a-d) of the impact body (34) at least some of the time.

3. A method according to claim 2, in which, for the throttling of different degrees, a spacing (a,a_{1,2}) and/or an angle of inclination (α) of the impact surface to the outlet opening (26) and/or a degree of overlap (G) between a cross sectional area (Q) of the fluid path (32) and the projection surface (A_{1,2}) of the impact surface (36,36a-d) on the cross sectional area (Q) is varied.

4. A method according to claim 3, in which, for the throttling to different degrees, the impact body (34) and the fluid path (32) are moved relatively to each other such that, each time they are moved relative to each other, different parts of the surface of the impact body (34) form impact surfaces (36,36a-d) introduced variously into the fluid jet (30) on account of the movement between different relative positions (R₁₋₄).

5. A method according to claim 4, in which the impact body (34) and the fluid path (32) are moved relative to each other by a rotational movement about an axis of rotation (46), wherein the impact body (34) in particular is rotated.

6. A method according to claim 4, wherein the impact body (34) and the fluid path (32) are moved relative to each other by a translatory movement.

7. A pressure modulator (24) having an outlet opening (26), which can be connected to a line (2) through which fluid (8) is flowing such that the outlet opening forms its exit end for the fluid (8), wherein the outlet opening (26) empties into a clearance (28), so that the fluid (8) during operation forms a fluid jet (30) emerging from the outlet opening (26) into the clearance (28) along a fluid path (32), and having an impact body (34) which can be introduced into the fluid path (32) in different ways, dynamically over time, forming at least some of the time an impact surface (36,36a-d), on which at least a portion of the fluid jet (30) impinges during operation.

8. A pressure modulator (24) according to claim 7, in which a spacing (a,a_{1,2}) and/or an angle of inclination (α) of the impact surface to the outlet opening (26) and/or a degree of overlap (G) between a cross sectional area (Q) of the fluid path (32) and a projection of the impact surface (36,36a-d) on the cross sectional area (Q) is variable.

9. A pressure modulator (24) according to claim 8, in which the impact body (34) and the fluid path (32) can be adjusted relative to each other so that, each time they are adjusted, different parts of the surface of the impact body (34) form impact surfaces (36,36a-d) protruding variously into the fluid path (32) on account of the adjustment between different relative positions (R₁₋₄).

10. A pressure modulator (24) according to claim 9, in which the impact body (34) and the fluid path (32) are rotatable relative to each other about an axis of rotation (46), wherein the impact body (34) in particular is rotatable.

11. A pressure modulator (24) according to claim 10, in which the fluid path (32) can be rotated eccentrically about an axis of rotation (64) relative to the impact body (34).

12. A pressure modulator (24), claim 9, in which the impact body (34) and the fluid path (32) can be moved in translation relative to each other.

13. A pressure modulator (24) according to claim 7, in which the impact body (34) has a surface topography, having a height profile and/or interruptions (52), which is distributed over the impact body (34) such that, when the impact body (34) is introduced variously into the fluid path (32), different segments of the surface topography lie alternately in the fluid path (32).

14. A pipeline arrangement (12) comprising:
a line (2) having an inlet (4) and an outlet (6) for the flow of a fluid (8) through the line (2) from the inlet (4) to the outlet (6), the pipeline arrangement (12) being part of a test layout (17) for a medical stent (18) with a test section (20) of the line (2) in which the stent (18) is placed, the line (2) able to be expanded by a pressure fluctuation (Δp) in the form of an increase in the pressure (p) of the fluid (8),
a delivery mechanism (14) for the fluid (8), in order to deliver the fluid (8) at the inlet (4) at a constant rate to the inlet (4) of the line (2),
a throttle element (16) for the fluid (8), in order to throttle the volume flow of the fluid (8) emerging from the outlet (6) to different degrees dynamically over time, especially periodically, in order to create dynamic pressure fluctuations (Δp) of the fluid (8) upstream in the line (2) by the change in the throttling.

15. A pipeline arrangement (12) according to claim 14, in which the delivery mechanism (14) is a pump (22) designed to feed a fluid (8) into the inlet (4) at constant rate and the throttle element (26) is a pressure modulator (24) connected in series with the outlet (6) downstream.
